(19) United States
(12) Patent Application Publication
(10) Pub. No.: US 2010/0105490 A1
(43) Pub. Date: Apr. 29, 2010

(54) MANUFACTURING METHOD OF WELD NUT MADE OF STAINLESS STEEL PLATE AND BLANKING PUNCH USED IN ITS MANUFACTURING METHOD

(75) Inventor: Hiroshi Shinjo, Osaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Shinjo Manufacturing Co., Ltd.

(21) Appl. No.: 12/582,736

(22) Filed: Oct. 21, 2009

(30) Foreign Application Priority Data
Oct. 23, 2008 (JP) JP2008-272744

(51) Int. Cl. B21D 53/24; B26F 1/14

(52) U.S. Cl. 470/22; 470/25; 83/682

(57) ABSTRACT

A manufacturing method of weld nut made of stainless steel plate capable of manufacturing a weld nut of a small size generally known as a micro-screw of thin type and nominal thread diameter of about M1.6 easily by blanking and processing a stainless steel plate, and a blanking punch to be used in this manufacturing method.

The manufacturing method of weld nut made of stainless steel plate includes a step of blanking and processing a tap drill hole 22 in a stainless steel plate material 20 having a thickness nearly equal to the height of the nut, a step of forming a nut main body 23 by blanking a nut outer shape in the material 20 around the tap drill hole 22, and simultaneously forming a plurality of weld protrusions 24 in the outer circumference of the bottom of the nut main body 23, and a step of processing female threads 25 in the inner circumference of the tap drill hole 22 of the nut main body 23. A blanking punch 5 used in blanking and processing of the nut outer shape is provided with a plurality of notch recesses 8 for forming weld protrusions 24 in the outer circumference of the lower end.

### TECHNICAL FIELD

The present invention relates to a manufacturing method of weld nut of thin type and small thread diameter (nominal diameter of about M1.6, usually called micro-thread) manufactured by blanking and processing of a stainless steel plate, and a blanking punch used in this manufacturing method.

### BACKGROUND ART

In assembling process of portable telephone and other small-sized electronic appliances, for example, using a mounting board of stainless steel thin plate of thickness of about 0.4 mm, a clinch nut of small thread diameter (nominal size of about M1.6) of similar stainless steel is crimped and bonded, and various parts and materials are fastened by screwing into the mounting board by using the clinch nut. However, by the clinch nut, it is inevitable that the cylindrical portion for crimping and bonding projects slightly to the back side of the mounting board. On the other hand, in the recent trend of thin and small size of portable telephones and other electronic appliances, such slight projection is not desired. To cut off the projecting cylindrical portion of the clinch nut, it is proposed to use a weld nut.

The weld nut is specified in JIS B 1196 in 1982, in which hexagonal, square, and T-type shapes are designated, but small sizes of thread nominal diameter M4 or less and stainless steel pieces are not specified. This is mainly because of difficulty in manufacturing. Of the weld nuts specified in the JIS, the T-type formed in a nut shape by drawing process of thin steel plate not processed by cold forging, and the “ID type” of square weld nut designated in Appendix Table 2 of the JIS capable of obtaining a weld protrusion by processing of tap drill hole by shearing and blanking from coil material of rectangular section, and drawing process of only four corners by releasing pattern of square nut obtained by cutting to a specified length had been historically manufactured and used before the establishment of the JIS.

However, in the manufacturing method of the weld nut specified the JIS, it has been difficult to manufacture a weld nut of stainless steel of thin nut main body (low in height) of nominal diameter of about M1.6, which is generally known as micro-screw as intended in the present invention.

### SUMMARY OF THE INVENTION

### Problems that the Invention is to Solve

The present invention is devised in the light of the above background, and it is hence an object thereof to present a manufacturing method of weld nut made of stainless steel plate capable of manufacturing a weld nut of small size called micro-screw of thin type and nominal thread diameter of about M1.6 easily by blanking process of a stainless steel plate, and a blanking punch used in this manufacturing method.

### Means for Solving the Problems

To achieve the object, the manufacturing method of weld nut made of stainless steel plate as set forth in claim 1 of the present invention includes a step of blanking and processing a tap drill hole in a stainless steel plate material having a thickness nearly equal to the height of the nut, a step of forming a nut main body by blanking a nut outer shape in the material in the center of the tap drill hole, and simultaneously forming a plurality of weld protrusions in the outer circumference of the bottom of the nut main body, and a step of processing female threads in the inner circumference of the tap drill hole of the nut main body.

The invention as set forth in claim 2 or 4 is intended to specify the portion for forming the weld protrusions, that is, in the case where the outer shape of the blanked and processed nut main body is hexagonal or square, the diagonal portions or opposite portions are specified, or in the case where the outer shape of the blanked and processed nut main body is round, plural positions spaced at specific intervals in the circumferential direction are specified.

The invention as set forth in claim 5 relates to a blanking punch to be used in blanking and processing of a nut outer shape in the manufacturing method of weld nut made of stainless steel plate of claim 1, in which a plurality of notch recesses for forming weld protrusions are provided in the outer circumference of the lower end of the blanking punch.

### ADVANTAGE OF THE INVENTION

According to the method of the present invention, a nut main body is formed by blanking and processing the outer shape of a nut in a stainless steel plate material having a thickness nearly equal to the height of the nut, and simultaneously a plurality of weld protrusions are formed in the outer circumference of the bottom of the nut main body, and hence a weld nut of stainless steel of small size called micro-screw of thin nut main body and thread nominal diameter of about M1.6 can be manufactured easily by simple blanking and processing, and a stainless steel nut of small size can be affixed to a mounting board of a portable telephone or other small electronic appliance made of a thin stainless steel plate without causing protrusions.

By using the blanking punch of claim 5, the manufacturing method of the weld nut of the present invention can be realized easily.

### BRIEF DESCRIPTION OF THE DRAWINGS

FIG. 1 is a longitudinal front view showing essential parts of a pressing machine for executing the manufacturing method of the present invention.

FIG. 2 is an explanatory diagram of forming process of a nut blank by the pressing machine.

FIG. 3 is a front view of essential parts of a blanking punch of the pressing machine.

FIG. 4 is a side view of essential parts of the blanking punch.

FIG. 5 is a bottom view of essential parts of the blanking punch.

FIG. 6 is an explanatory diagram of forming process for forming a nut main body and weld protrusions by the essential parts of the blanking punch, in which (a) shows a starting time of blanking by shearing process of the outer shape of the nut main body, (b) shows a process of blanking, and (c) shows completion of blanking and formed state of weld protrusions.

FIG. 7 shows principal parts of a known automatic tapping machine for processing female threads in a tap drill hole of the nut main body, in which (a) is a lateral cross plan view of essential parts, and (b) is a sectional view along line b-b in (a).

FIG. 8 shows a completed hexagonal weld nut, in which (a) is a plan view, (b) is a front view, and (c) is a bottom view.

FIG. 9 shows a hexagonal weld nut in other preferred embodiment of the present invention, in which (a) is a plan view, (b) is a front view, and (c) is a bottom view.

FIG. 10 is a contrast explanatory diagram of using states of the weld nut of the present invention, in which (a) shows a using state of a hexagonal weld nut 26 having weld protrusions provided at diagonal positions, and (b) shows a using state of a hexagonal weld nut 27 having weld protrusions provided at opposite positions.

FIG. 11 shows a round weld nut in other preferred embodiment of the present invention, in which (a) is a plan view, (b) is a front view, and (c) is a bottom view.

FIG. 12 shows a square weld nut in other preferred embodiment of the present invention, in which (a) is a plan view, (b) is a front view, and (c) is a bottom view.

FIG. 13 shows a hexagonal weld nut in other preferred embodiment of the present invention, in which (a) is a plan view, (b) is a sectional view along line b-b in (c), and (c) is a bottom view.

### PREFERRED EMBODIMENTS FOR CARRYING OUT THE INVENTION

Preferred embodiments of the present invention are described below by reference to the drawings.

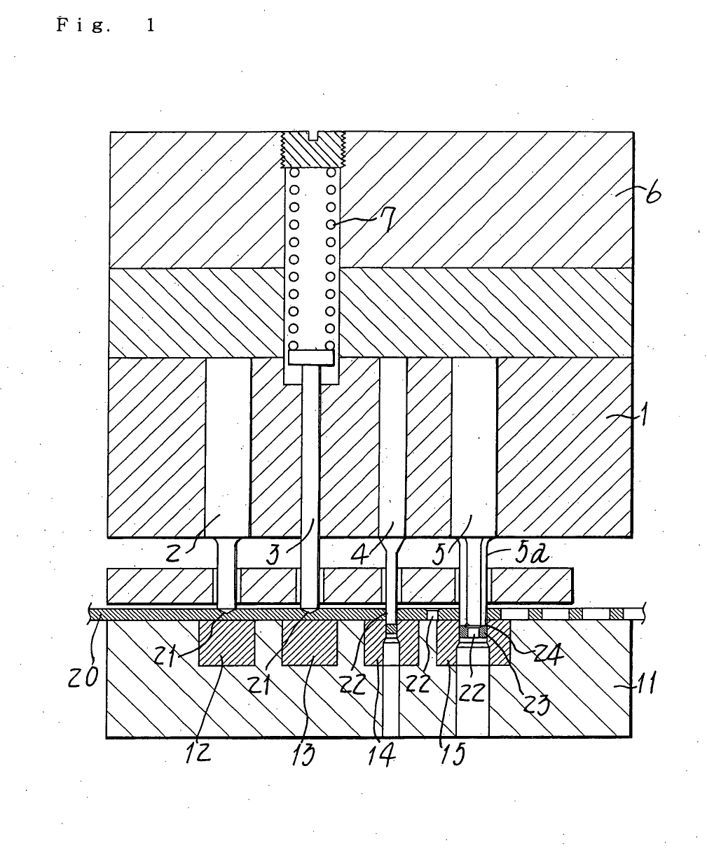

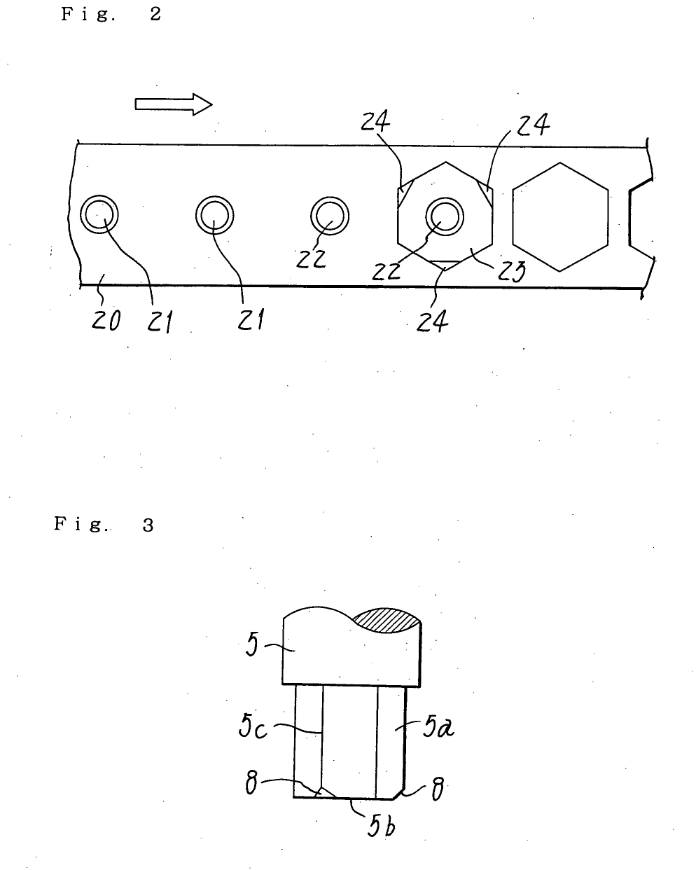

FIG. 1 shows essential parts of a pressing machine of forward feeding type for executing the manufacturing method of a weld nut made of stainless steel plate the present invention, and FIG. 2 is an explanatory diagram of forming process of a nut blank as the main body of the weld nut by the pressing machine.

In the pressing machine shown in FIG. 1, a punch holder 1 includes a preliminary forming punch 2 of a tap drill hole, a pilot pin 3 for correcting the feed pitch of a material 20 described later to set to a correct pitch, a drilling punch 4 of the tap drill hole, and a blanking punch 5 for blanking the outer shape of a hexagonal nut and simultaneously forming weld protrusions, which are aligned and arranged at specific equal pitches in the feed direction of the material 20. Further, die holder 11 is provided with a preliminary forming die 12, a pilot pin die 13, a drilling die 14, and a blanking die 15 corresponding respectively to the preliminary forming punch 2, the pilot pin 3, the drilling punch 4, and the blanking punch, which are aligned and arranged at specific equal pitches in the feed direction of the material 20.

The pilot pin 3 penetrates through the punch holder 1 and is assembled movably in vertical direction, and is forced downward by a push spring 7 provided in a base board 6 for mounting the punch holder 1.

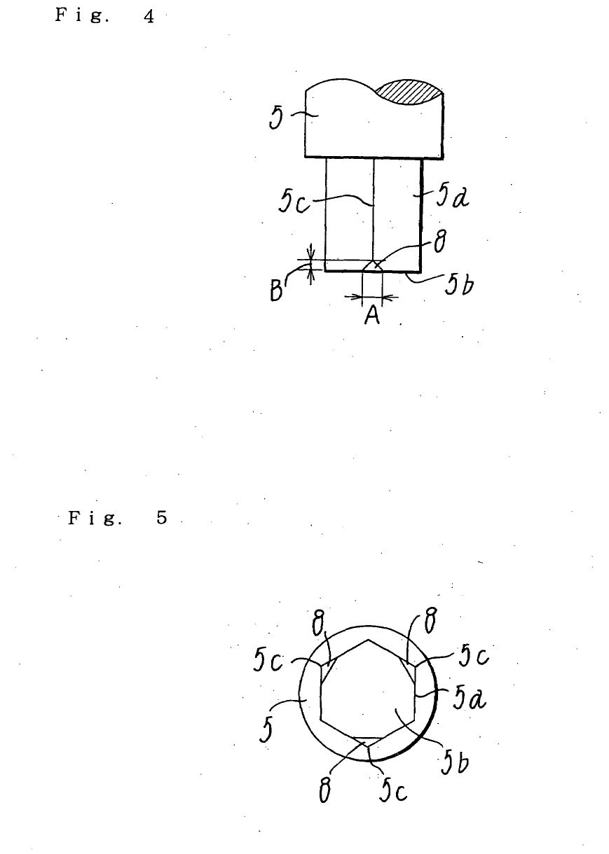

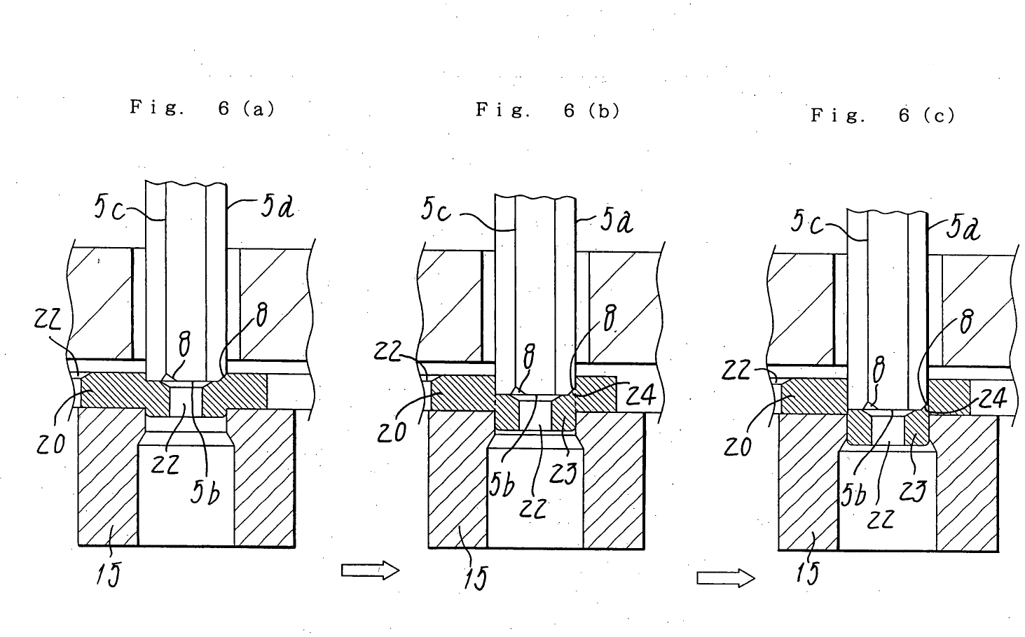

The blanking punch 5 is provided with, as shown in FIG. 3 to FIG. 5, a hexagonal columnar punch portion 5a corresponding to the profile shape of the hexagon nut in cross sectional view, and notch recesses 8 are provided for forming weld protrusions 24 described below at three diagonal positions of the outer circumference of the lower end of the columnar punch portion 5a. The notch recesses 8 are, as shown in FIG. 4, formed in a triangular pyramid shape, having a specified width A at a lower end 5b of the columnar punch portion 5a, and converging at specified height B toward ridges 5c at diagonal portions from both ends of width A, and weld protrusions having a specified weld nugget area and weld strength are formed.

The material 20 is a stainless steel plate of band shape having a thickness (about 1.3 mm) nearly equal to the height of the nut to be manufactured, and the material 20 is supplied into the pressing machine 1 in FIG. 1 and pressed and processed by a forward feed pattern, and as shown in FIG. 2, the processing for forming a preliminary recess 21 of a tap drill hole 22 by the preliminary forming punch 2, the process for blanking the tap drill hole 22 by the drilling punch 4, the process for forming the nut main body 23 by blanking and processing the outer shape of the hexagon nut in the center of the tap drill hole 22 by the blanking punch 5, and the process for forming weld protrusions 24 by the notch recess 8 at three diagonal positions of the nut main body 23 are carried out simultaneously and continuously by intermittent feed at equal pitches. At this time, during pitch feed of the material 20, the pilot pin 3 is engaged with the preliminary recess 21, and error in feed pitch is corrected, and an accurate feed pitch is always maintained.

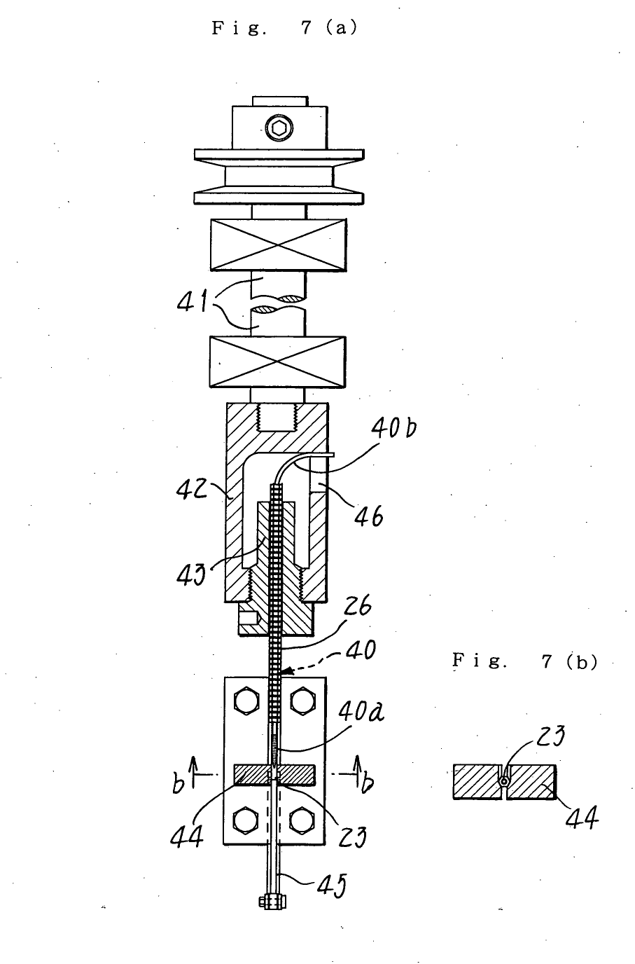

The essential element of the present invention, that is, the simultaneous processing of blanking of the nut main body 23 by the blanking punch 5, and forming of weld protrusions 24 is achieved as shown in FIG. 6, that is, the outer shape of the hexagonal nut main body 23 is blanked and processed by shearing by the columnar punch portion 5a, and simultaneously three diagonal positions of the nut main body 23 are squeezed and processed by the notch recess 8, and weld protrusions 24 of triangular pyramid shape having specified width A and height B are protruded and formed in the outer circumference of the bottom side of the nut main body 23.

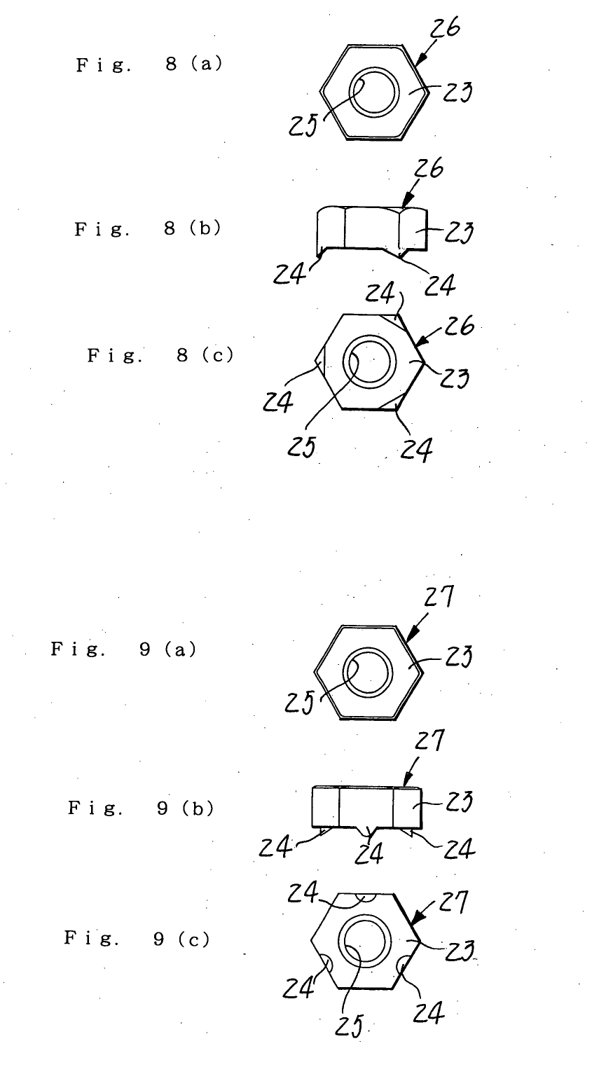

The nut main body 23 thus processed by pressing is supplied into the tapping process shown in FIG. 7, and female threads 25 are formed in the inner circumference of the tap drill hole 22, and a hexagonal weld nut 26 is completed as shown in FIG. 8.

FIG. 7 shows principal parts of a known automatic tapping machine using a bend tap 40, and the bend tap 40 is disposed by penetrating through a support tube 43 fitted to a tubular rotating body 42 coupled to a rotation drive shaft 41, and the nut main body 23 supplied through a chute 44 is forwarded into a tap portion 40a of the bend tap 40 by a nut push rod 45, and threads are tapped in the tap drill hole 22. After the tapping process, the hexagonal weld nut 26 is automatically sent out through a curved handle portion 40b of the bend tap 40, and is discharged from a discharge port 46 provided in the tubular rotating body 42.

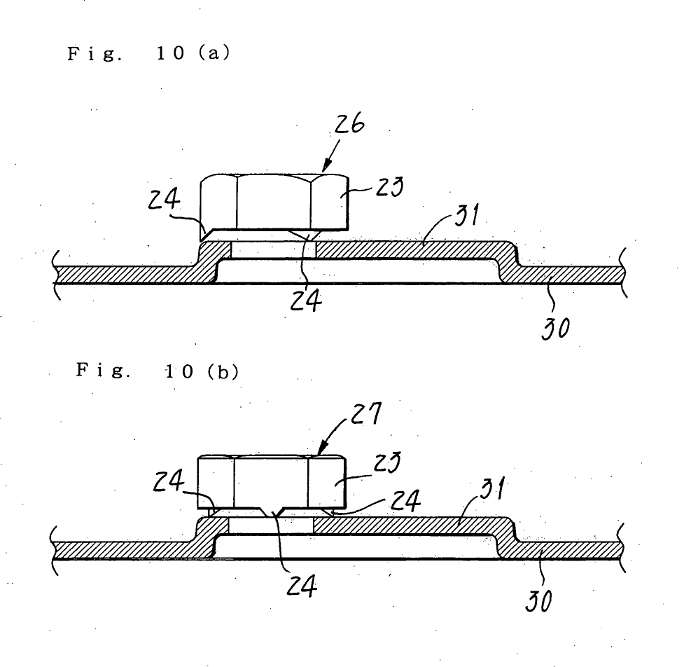

FIG. 9 shows a weld nut 27 according to other preferred embodiment of the present invention. This weld nut 27 is hexagonal in the shape of the nut main body 23 same as in the preferred embodiment shown in FIG. 8, but is different in that the weld protrusions 24 are formed at three opposite positions of the nut main body 23. This hexagonal weld nut 27 having the weld protrusions 24 formed at opposite positions is advantageous when welding in a limited space of the mounting board. For example, as shown in FIG. 10, when fitting weld nuts to corners of embossed portions 31 of a mounting board 30, in the case of the hexagonal weld nuts 26 having weld protrusions 24 formed at diagonal positions as shown in FIG. 8, the weld protrusions 24 may be apart from the welding space as shown in FIG. 10 (a), but in the case of the hexagonal weld nuts 27 having weld protrusions 24 formed at opposite positions as shown in FIG. 9, the weld protrusions 24 are not apart from the welding space as shown in FIG. 10 (b), and a successful welding is realized.

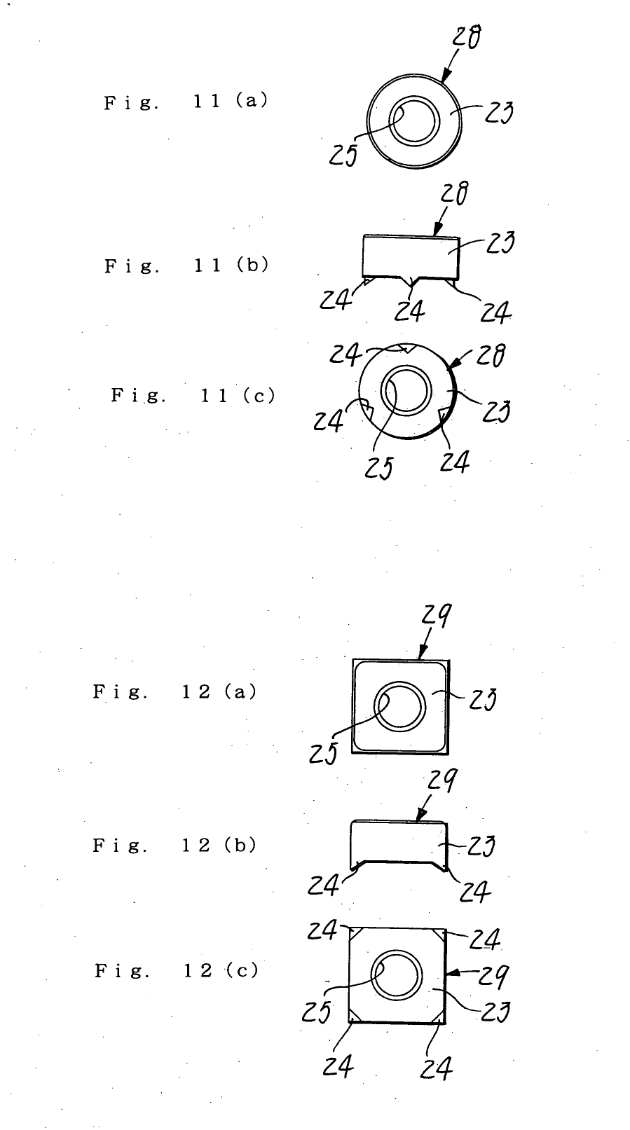

FIG. 11 shows a weld nut 28 according to another preferred embodiment of the present invention. This weld nut 28 is round in the shape of the nut main body, and weld protrusions 24 are formed in the circumferential direction at specified intervals.

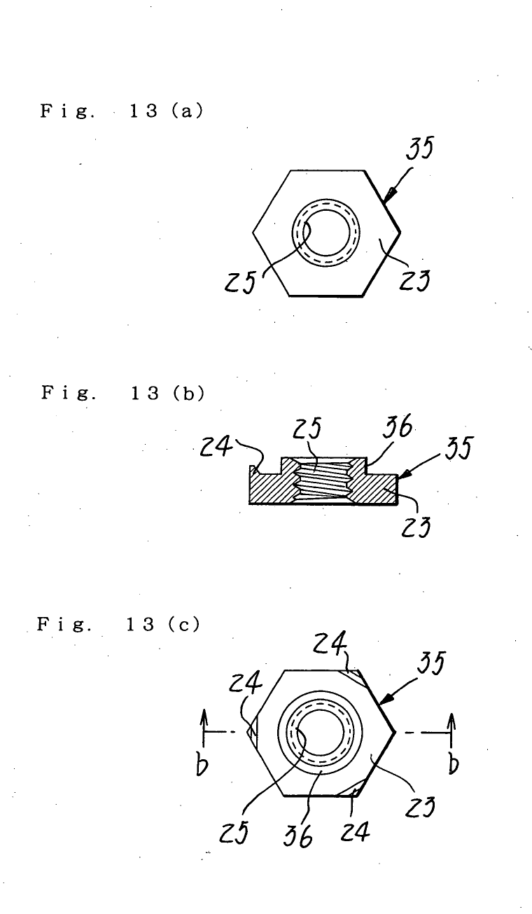

FIG. 12 shows a weld nut 29 according to a different preferred embodiment of the present invention. This weld nut 29 is square in the shape of the nut main body, and weld protrusions 24 are formed at four corners.

FIG. 13 shows a weld nut 35 according to a still different preferred embodiment of the present invention. This weld nut 35 is a modified example of the preferred embodiment shown in FIG. 8, and at the bearing surface side of the hexagonal nut main body 23, female threads 25 are formed concentrically with tubular pilot portions 36 for positioning. The pilot portions 36 project in the axial direction from the weld protrusions 24. Such pilot portions 36 are from the known technology employed in the conventional weld nuts.

### DESCRIPTION OF THE REFERENCE NUMERALS AND SIGNS

1 Punch holder
2 Preliminary forming punch
3 Pilot pin
4 Drilling punch
5 Blanking punch
5a Columnar punch portion
5b Lower end face of columnar punch portion 5a
5c Ridge of columnar punch portion 5a
8 Notch recess
20 Material
21 Preliminary recess
22 Tap drill hole
23 Nut main body
24 Weld protrusion
25 Female thread
26 Hexagonal weld nut
27 Hexagonal weld nut
28 Round weld nut
29 Square weld nut
30 Mounting board
35 Hexagonal weld nut
36 Pilot portion

1. A manufacturing method of weld nut made of stainless steel plate comprising:
a step of blanking a tap drill hole in a stainless steel plate material having a thickness nearly equal to the height of the nut,
a step of forming a nut main body by blanking and processing a nut outer shape in the material in the center of the tap drill hole, and simultaneously forming a plurality of weld protrusions in the outer circumference of the bottom of the nut main body, and
a step of processing female threads in the inner circumference of the tap drill hole of the nut main body.

2. The manufacturing-method of weld nut made of stainless steel plate according to claim 1, wherein the outer shape of the blanked and processed nut main body is hexagonal or square, and the weld protrusions are formed in the diagonal portions.

3. The manufacturing method of weld nut made of stainless steel plate according to claim 1, wherein the outer shape of the blanked and processed nut main body is hexagonal, and the weld protrusions are formed in the opposite portions.

4. The manufacturing method of weld nut made of stainless steel plate according to claim 1, wherein the outer shape of the blanked and processed nut main body is round, and the weld protrusions are formed in the circumferential direction at specified intervals.

5. A blanking punch to be used in blanking and processing of a nut outer shape in the manufacturing method of weld nut made of stainless steel plate of claim 1, wherein a plurality of notch recesses for forming weld protrusions are provided in the outer circumference of the lower end of the blanking punch.
